(19) United States
(12) Patent Application Publication
(10) Pub. No.: US 2003/0174582 A1
(43) Pub. Date: Sep. 18, 2003

(54) Multi-interval seismic line cable system for distributed electronics

(76) Inventor: Gary Scott, Sugar Land, TX (US)

Correspondence Address: Alan J. Atkinson, P.O. Box 270161, Houston, TX, 77277-0161, US

(21) Appl. No.: 10/097,826

(22) Filed: Mar. 14, 2002

(51) Int. Cl. H04R 1/00

(52) U.S. Cl. 367/178

(57) ABSTRACT

A system for gathering and recording seismic data. The system provides cable sections having takeouts at predetermined locations for connection to a string data module and attached sensor string. Additional data strings can be connected to vary the sensor orientation and spacing at different positions within a seismic array. Data is collected by sensors attached to each sensor string and is transmitted through the corresponding string data module and to an intermediate data manager. The data is transmitted at a high delivery rate to a master recording unit. Transverse data managers can be connected in large arrays between intermediate data managers and the master recording unit to provide additional control or data processing attributes, and local recorders can provide data processing and transmission attributes before the data is transmitted to the master recording unit. The system architecture contains multiple levels of data paths each having successively higher data rates. Multiples of lower paths feed into the higher paths and multiples of these paths feed into successively higher data paths. Each level of the data path architecture can stand alone such that each level provides line transmission functions asynchronously to the other levels.

### BACKGROUND OF THE INVENTION

The invention relates to the field of seismic exploration. More particularly, the invention relates to an improved system for collecting and recording seismic data.

Seismic exploration generates seismic source energy. The energy propagates downwardly through subsurface geologic structures and is partially reflected from interfaces between geologic structures. The reflected signal impulses travel upwardly and are detected with sensors at the surface.

Seismic exploration is often performed in areas difficult to traverse such as jungles, swamps, mountains, deserts, and populated areas. Movement of equipment in such areas is complicated because seismic data processing requires a seismic line cable system capable of gathering data from an extremely large number of field electronic units and seismic sensors. Large seismic spreads simultaneously deploy hundreds of thousands of sensors. Digital data generated by such sensors must be moved quickly and efficiently through ground equipment and recorded for future analysis and processing. One technique for communicating seismic signals to a recording unit was disclosed in U.S. Pat. No. 5,627,798 to Siems and Scott (1997), entitled “Hierarchical Telemetry System for Seismic Acquisition”.

A seismic data gathering system preferably distributes the data paths and direct control units through a hierarchy of data path levels. Each level typically operates at different data rates and over different transmission distances to provide optimised data paths. Path definition is dependent on the quantity of data and next destination of the transmitted data packets. The physical layout of equipment for each survey typically changes depending upon the anticipated geology, data requirements, and physical topography.

Current system designs provide interconnected line cables manufactured in lengths dedicated to match the separation distance between adjacent electronic stations or sensor stations. The configuration of conventional deployment systems is limited by the cable and position of takeouts along the cable. Accordingly, conventional design requires manufacture and purchase of multiple cable sets having different lengths sufficient to address each possible survey configuration. If cables of the required lengths are not available a seismic crew must purchase additional cables and other equipment to perform the specific survey.

Where shorter survey cable lengths are required for a particular survey but a crew only possesses longer length cables, the extra unnecessary cable weight increases the survey cost, slows production rates, and increases the risk of injury to ground equipment handlers. Dependence upon conventional cable equipment further limits field changes or adjustments because of the remoteness and equipment handling requirements of seismic equipment.

One form of multiple-choice cable system has been used in seismic operations with analog type cables. This system is limited to six or fewer channels or stations per cable, is heavy due to the requirement for separate wires per station, and is troublesome due to extremely low level of the signal being handled. Signal amplitudes in the micro volt region are common with analog systems and cause inherent problems with inter-channel crosstalk and degradation of the desired signal because environmental moisture creates extremely small amounts of stray signal paths within the cable.

A need exists for an improved seismic data collection system capable of permitting efficient deployment of seismic equipment and of facilitating the collection, transmission and processing of seismic data. The system should be configurable in different arrangements and should facilitate deployment of large seismic spreads containing hundreds of thousands of sensors.

### SUMMARY OF THE INVENTION

The invention provides an apparatus and system for collecting seismic data. The apparatus comprises a cable section having at least two takeouts at selected locations along the cable section, at least one string data module attachable to one of the takeouts, wherein the string data module includes electronics for transmitting data through the cable section, a sensor string having one end attached to the string data module, and at least one sensor attached to the sensor string for generating seismic data for transmission through the string data module and the cable section. More than one sensor string can be connected to modify the number and distance of sensors providing data to the string data module.

In other embodiments of the apparatus, an intermediate data manager can be connected to one end of the cable section for receiving the data transmitted through the cable section, and a master recording unit can be linked in communication with the intermediate data manager for receiving and recording the data. A transverse data manager can be linked between the intermediate data manager and the master recording unit, and a local recorder can be linked therebetween for the purpose of selective data storage before such data is retrieved manually or is transmitted to the master recording unit.

The system of the invention comprises a plurality of cable sections each having at least two takeouts at selected locations along the cable section, a plurality of string data modules each attachable to selected takeouts wherein each string data module includes electronics for transmitting data through the corresponding cable section, a sensor string having one end attached to each string data module wherein each sensor string includes at least one sensor for generating seismic data for transmission through the corresponding string data module and cable section, and an intermediate data manager linked with the cable sections for receiving the data.

### BRIEF DESCRIPTION OF THE DRAWINGS

FIG. 1 illustrates a cable section having multiple takeouts.

FIG. 2 illustrates a string data module attached to a sensor string.

FIG. 3 illustrates multiple string data modules and attached sensor strings attached to a cable section.

FIG. 4 illustrates a parallel connection between adjacent intermediate data managers, and FIG. 5 illustrates a series connection therebetween.

FIG. 6 illustrates a 3D spread having four transverse data managers linked with a master recording unit.

FIG. 7 illustrates a 3D spread having 180 channels.

FIG. 8 illustrates multiple transverse lines for a 180 channel spread.

FIG. 9 illustrates a system having local recorders.

FIG. 10 illustrates a system configuration for 388,800 channels.

### DESCRIPTION OF THE PREFERRED EMBODIMENTS

The invention provides a unique seismic collection and recording system structure for seismic equipment deployed in a multi-level structure. The invention provides multiple choice options for the distance separating individual field electronic sensor stations, operating from a single line cable length, with a number of pre-defined separation intervals that may be selected for use. Such flexibility permits the same seismic assets to be used in multiple configurations having various separation intervals, and permits field modification of the separation intervals at discrete positions within a seismic sensor array.

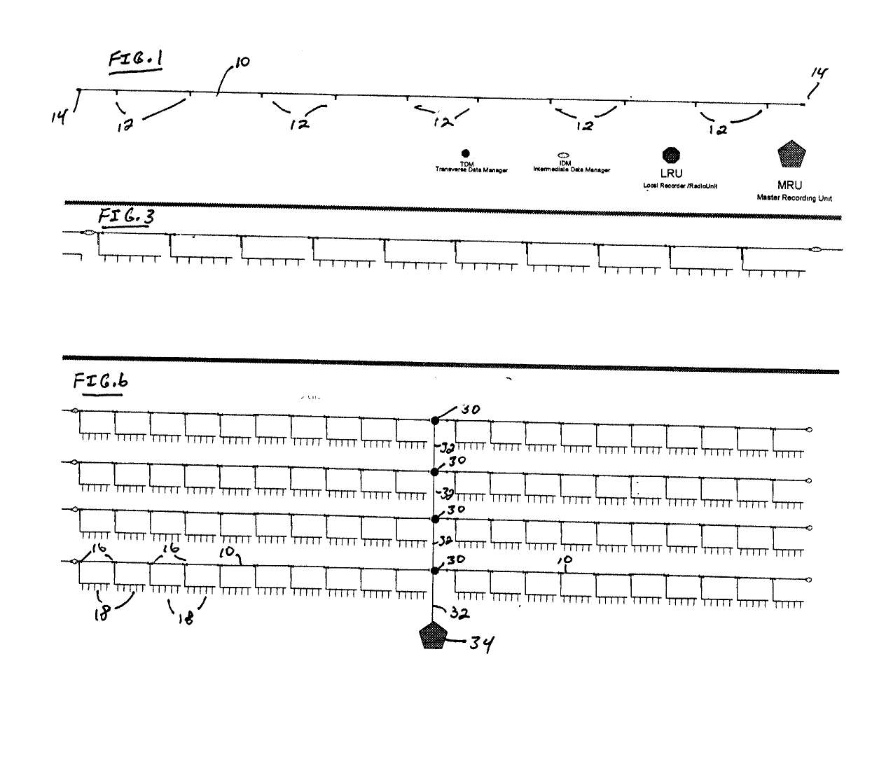

FIG. 1 illustrates cable section 10 having multiple takeouts 12 and end connectors 14. Although the length of cable section 10 can be varied, and the number of takeouts 12 can be varied, and spacing between takeouts 12 within cable section 10 can be nonuniform, a preferred embodiment of the invention uses a uniform number of takeouts 12 along a standard length of cable section 10 with equal and uniform spacing between adjacent takeouts 12. The purpose of such preferred uniformity is further described below.

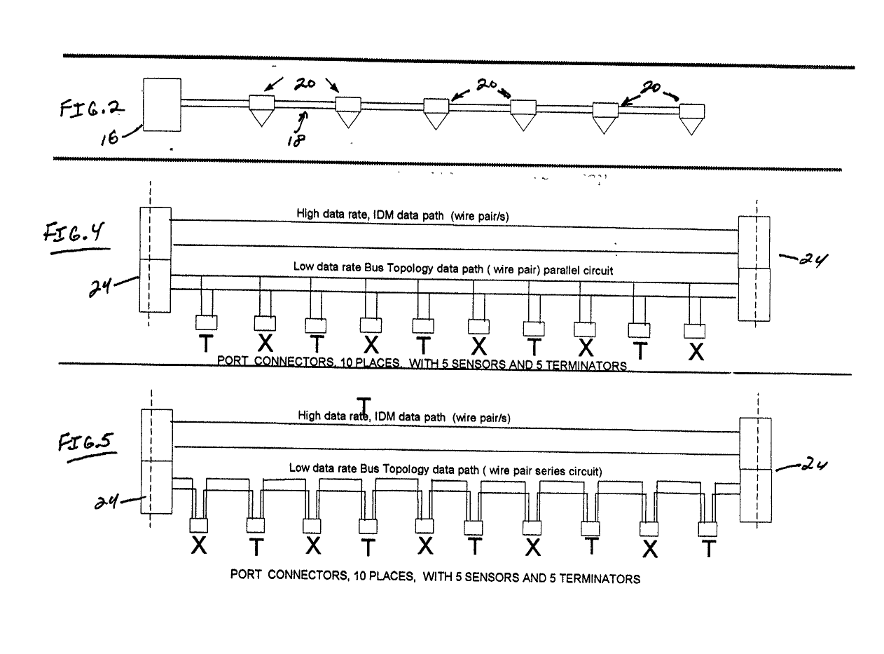

FIG. 2 illustrates a single string data module (“SDM”) 16 attached to sensor string 18. SDM 16 comprises an electronic data command and processing module connectable to a takeout 12 along cable section 10. Sensor string 18 comprises a circuit containing numerous motion or pressure sensors 20 distributed along a relatively short length of cable. Sensors 20 are preferably spaced at equal intervals along sensor string 18, however the spacing can be varied as described below. A convenient length of sensor string 18 is twenty-five meters, however such length can be varied as described below. Each sensor string 18 can contain electronics to digitise the incoming signal waveforms such as conventional analog transducers or may comprise a selected quantity of digital signal transducers. Connector 22 is attached to the end of sensor string 18 opposite SDM 16 for permitting connection of connector 22 to another SDM 16 attached to a secondary sensor string 18. In this manner the length of sensor string 18 can be extended by the simple connection of an additional sensor string 18 having additional sensors 20. The sensor strings 18 and SDMs 16 connected together can be recorded individually or summed together within integrated line electronics and can be recorded as an extended single sensor array. By providing these design capabilities the system extends geophysical receiver design options beyond the line cables dimensions.

Each sensor 20 produces data which can be transmitted in a data packet through sensor string 18 to SDM 16. Sensor string 18 provides power from cable section 10 to electronics within each sensor 20 and further provides a return path to move the digitised data packets back “up stream” through SDM 16. SDM 16 can provide a low level of data processing capability such as the capability of summing data from individual sensors 20 or sensor strings 18 into a single data word. Each SDM 16 preferably comprises a “smart connector” connected to takeout 12 in that SDM 16 contains a passive circuit to identify the particular SDM 16 and the location of such SDM 16 along cable section 10. SDM 16 can also include or can be connected to a GPS receiver for the purpose of identifying geographic location for SDM 16 at each point in time. An intermediate data manager (“IDM”) 24 can determine the sequence and position in the sequence of an SDM 16 within its control through measurements of line power IR attenuation down the line, and/or time delay of communication data response with each SDM 16.

The sequence of SDMs 16 and position of each SDM 16 along cable section 10 may be determined electronically after connection to cable section 10 and is no longer determined by the cable's physical length and construction. This feature of the invention permits automated field configuration assessment and confirmation before data gathering operations are commenced and after such operations are concluded, thereby reducing system error and increasing system reliability.

More than one cable section 10 can be connected together before an IDM 24 is positioned, thereby permitting flexibility in designing and constructing the location of IDMs within a seismic array. Such design flexibility coupled with the unique data processing and transmission capabilities of the invention permit greater distance between SDMs 16 and IDMs 24 than is utilized in conventional seismic data gathering systems.

Although SDM 16 and connected sensor string 18 comprise the basic building block of a distributed electronics system, each SDM 16 and connected sensor string 18 can be selectively attached to takeouts 12 along cable section 10 as shown in FIG. 3. Each end of cable section 10 or a series of similar cable sections 10 is attachable to an IDM 24 which comprises electronics and software to manage and control the gathering of data from lower levels of electronics within sensors 20. IDM 24 can provide multiple capabilities such as the capacity to guide sensor 20 tests, can provide testing and data processing of data packets collected by SDMs 16, can provide temporary data storage buffers and can provide line cable testing within cable section 10 or within individual sensor strings 18. In addition to these capabilities, IDM 24 can provide reception and transmission of data packets on both the lower level with SDMs 16 and on the intermediate level with other IDMs 24 or to one of another higher level module as described below. IDMs 24 also provide a source of operating power downstream by converting an input external power source, such as a battery, or other suitable portable power source, into a regulated power of suitable voltage level for use by SDMs 16 downstream.

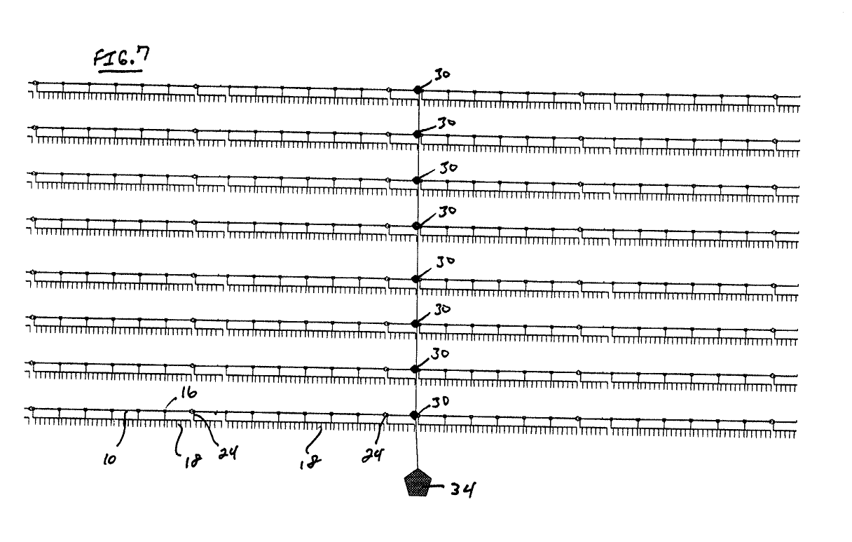

FIGS. 4 and 5 provide schematic variations for wiring combinations between adjacent IDMs 24. High data rate wire pair 26 is capable of transmitting data directly between adjacent IDMs 24. In addition, FIG. 4 illustrates a parallel circuit for a low data rate bus topology data path linking port connectors in ten places with five sensors (“X”) and five terminators (“T”). FIG. 5 illustrates a series circuit linking port connectors in ten places with five sensors (“X”) and five terminators (“T”).

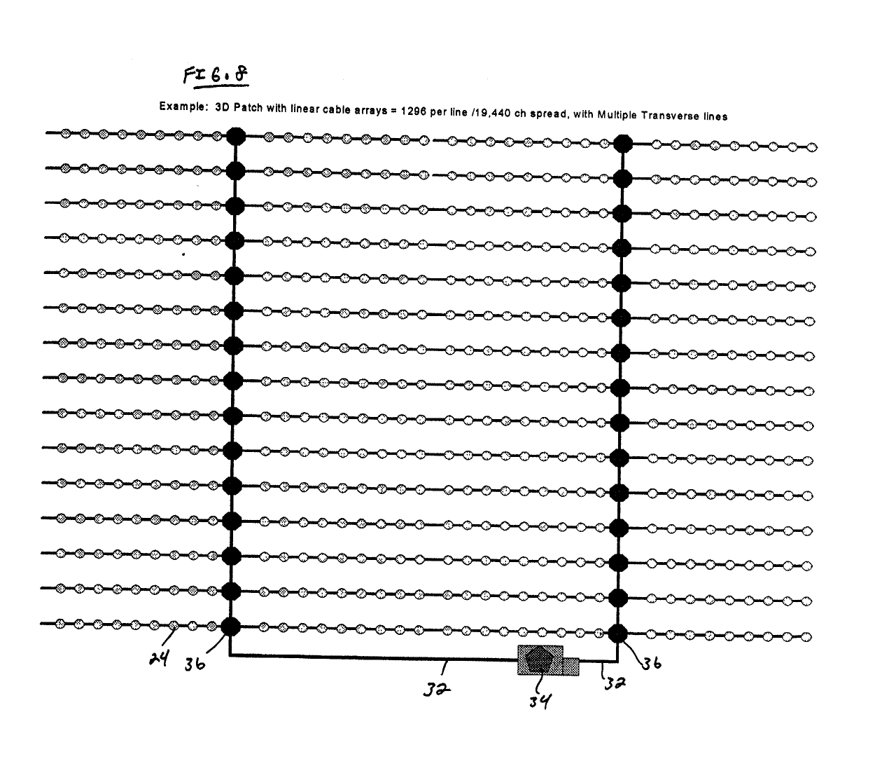

FIG. 6 illustrates a typical 3D seismic spread having multiple cable sections 10 and multiple SDMs 16 and IDMs 24 configured therein. Each IDM is attached through a cable section 10 to a transverse data manager (“TDM”) 30, which in turn is linked through lines 32 with master recording unit 34. Lines 32 can comprise a wire line cable, fiber optic cable, or radio link. Each TDM 30 provides a high data path across lines 32 carrying data towards master recording unit 34. Each TDM 30 can manage multiple electronic data paths including (i) the lower level with IDMs 24, and (ii) the higher level with other TDMs 30 units or with master recording station 34. Each TDM 30 can provide large temporary storage data buffers, can provide command control of selective IDMs 24 or SDMs 16, can provide select data processing capabilities, and can provide operating power from an external portable source to be converted and regulated for cable section 10 to pass down the line.

Each of the upper level command and processing modules such as an IDM 24, TDM 30 or local recorder 36, can contain electronics to provide electrical operating power for the system electronics communicating down the data conductors within each cable section 10. Electrical power in return can originate from an external source such as batteries or other portable DC power sources. Internal electronics convert the raw input power source to a regulated voltage of a value suitable to be supplied down each cable section 10. Other modules such as SDMs 16 down the line can either supply similar power conversion or can use electrical power supplied from another SDM 16 before such power is transmitted further downstream.

Master recording unit 34 comprises the final destination for data and can provide the origin of command and control for the entire system. Master recording unit 24 provides recording ability for data transmitted back from individual components, provides command and control functions for system operations, and commands local line components to perform tests of transmission media and the quality of the recorded data. In addition, master recording unit 34 can provides data quality assurance through monitoring of local testing and analysis of data and through visual display of the data by forming a paper plot or video screen display for the data and testing analysis result reporting.

FIG. 6 provides an example of four seismic lines having ten takeouts 12 connected to each cable section 10, with an IDM 24 between adjacent cable sections 10. A TDM 30 is connected to each seismic line and the four TDMs 30 are linked with master recording unit 34.

FIG. 7 illustrates another configuration of eight seismic lines each having six phones per each SDM 16, with six SDMs 16 connected to each cable section 10 and associated IDM 24, for a combined total of thirty-six channels for each IDM 24. With the illustrated configuration of five IDMs 24 for each seismic line, the number of channels connected to each TDM 30 is one hundred eighty.

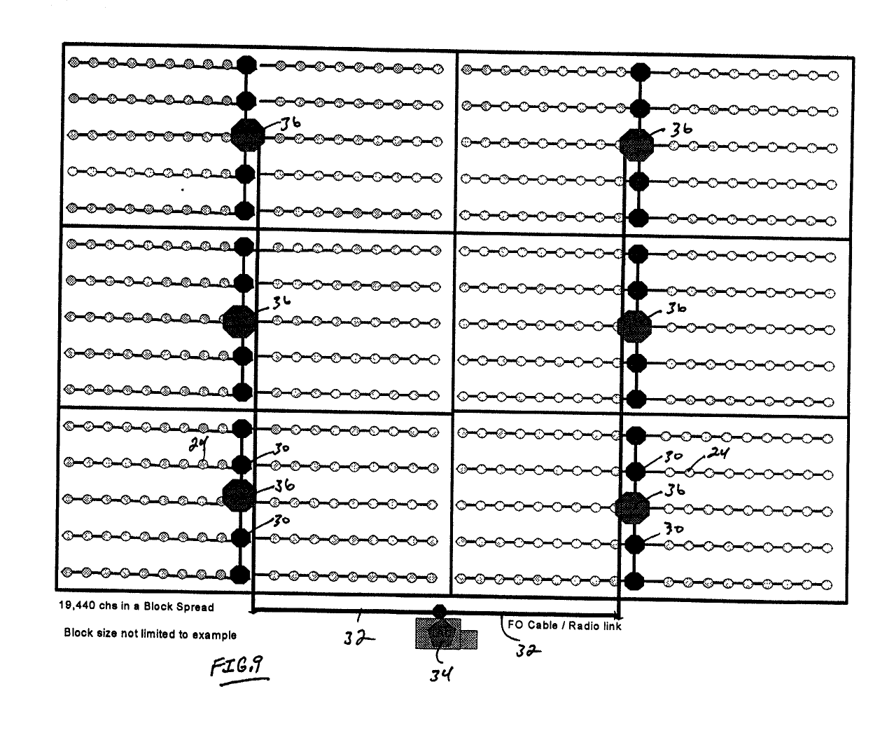

FIG. 8 illustrates another system configuration suitable for 3D seismic data gathering wherein multiple transverse lines are connected to TDMs 30. The IDMs 24 associated with each TDM 30 provide 1296 channels for a total spread of 19,440 data channels transmitted to master recording unit 34.

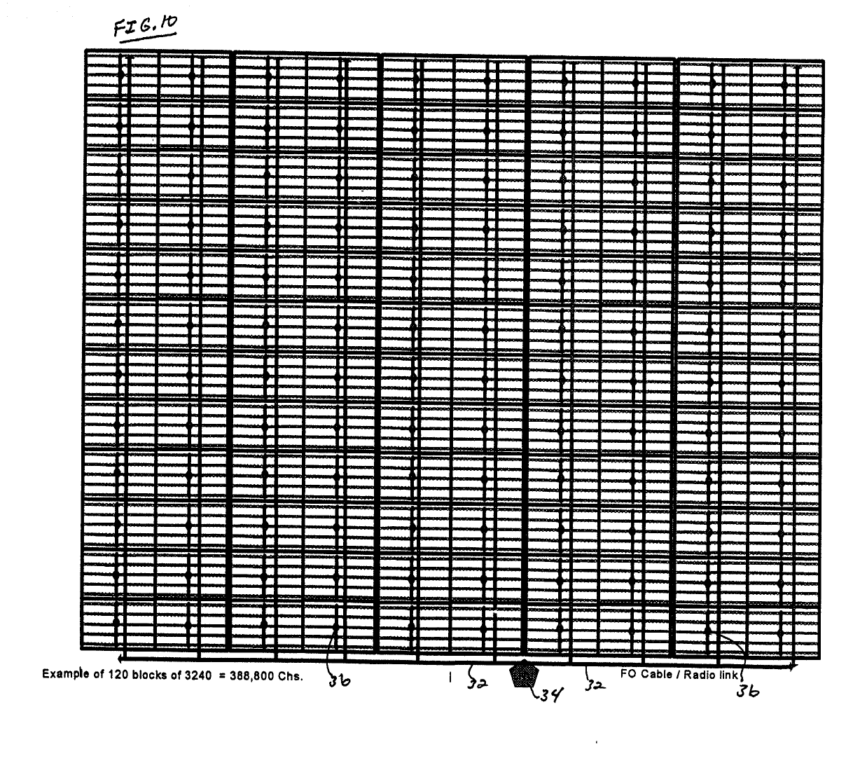

FIG. 9 illustrates another system configuration for a total block spread of 19,440 channels wherein local recorders 36 are selectively connected between TDMs 30 and master recording unit 34. Each local recorder 36 provides command and control down the line to TDMs 30 and also provides one of server functions for transferring data packets being recorded. Each local recorder 36 can provide a local recording media to store large amounts of data within a discrete, defined module until the recorded data is retrieved electronically or the recording media is retrieved and replaced with blank media. When local recording is provided by this embodiment, local recorder 36 can provide command and control down line and quality testing of the data recorded. A low speed transmission provides communications with master recording unit 34 and transmission of quality control data through cable or radio mechanisms back to master recording unit 34. Each local recorder 36 can also provide an option for ultra high speed line transmission to master recording unit 34 through a fiber optic cable assembly, through radio transmission, or other transmission technique. Selection of these options may be determined by local national environment and laws.

FIG. 10 illustrates another system configuration showing one hundred twenty blocks each having 3,240 channels for a total of 388,800 channels collecting and transmitting data to a single master recording unit 34, or recording at local recorder 36, and passing quality assurance data back to master recording unit 34.

The structure of the system comprises multiple hierarchy levels which can typically range between three to five with additional levels possible. Each level can have its own data transmission speed, command and control structure, equipment test, quality assurance capabilities, and data processing. The system provides seismic data testing and quality assurance and reporting capabilities, including “wiggle trace” data monitoring and display schemes within the system data transfer rates.

The system levels each have increasing capabilities for speed and amount of data to be carried at each level, and the distance the date packets are to be transmitted uninterrupted. The system permits asynchronous data transmission in that data can move at different times and at different rates at different points within the network. Because of the system configuration, data transmitted down a cable at any level will not pass through the electronic paths of other levels. Data transmitted from a local SDM 16 to an assigned command controller or IDM does not pass through other SDM 16 sensor units. The invention's separation of the data paths into different levels decreases required transmission speed at lower levels and allows for higher speed dedicated paths for higher levels. Each level further decreases total power requirements for the system by significantly reducing the number of data repeaters in the data path by a factor of several hundred. The reduction is dependent on the number of channels involved and other factors.

The line cables in the system can contain multiple circuit levels, permitting a slower SDM 16 data path for a number of SDMs 16 to gather data and to pass such gathered data to the assigned IDM 24 down the assigned data path. From an IDM 24 the data is moved up to the next higher level to be transmitted directly to another IDM 24 down the line, or to a higher level units such as a TDM 30 to continue the journey toward either a local recorder 36 or master recording unit 34. The data path level for each IDM 24 provides for separate and higher speed data paths for transmitting data packets uninterrupted over long distances, thereby bypassing local SDM 16 data gathering units along the data transmission path.

The system ability to transmit SDM 16 communications directly to an IDM 24 and for each of the higher level modules to transmit data without passing through any of the lower unit electronics reduces power requirements and increased the total data rate capability of the system.

SDMs 16 may be connected directly to the system line at a smart connector, or a number of sensor strings 18 may be connected together end-to-end with a SDM 16 connected to cable section 10 as master SDM controlling the operation of additional SDMs connected downstream. This ability to connect sensor strings 18 together permits standard lengths to be carried into the field, while permitting significant flexibility in the length and number of sensors 20 tied into each takeout 12. Virtually unlimited field modifications can be made to the sensor 20 placement by using standard dimension equipment uniquely linked together by the principles of the invention. These directly connected sensor strings 18 may then be retrieved and recorded as individual sensor arrays or may be summed together in the line electronics (SDM 16 or IDM 24) and sent as a single sensor array of an extended physical length.

SDMs 16 are connected into the main system with a line system structure that allows for these connections to occur at any of a number of predefined connection points along the length. Takeouts 12 can be positioned at essentially any spacing and orientation along cable section 10, however uniform spacing of takeouts 12 facilitates sensor 20 orientation in an overall seismic spread. One advantage of this system design is that various sensor connections can be made in varying degrees of density and configuration as various takeouts 12 are or are not used in a particular seismic spread.

The preferred system architecture contains a multiple of levels of data paths, each with successively higher data rates. Multiples of the lower paths feed into the higher paths, and multiples of these paths feed into successively higher data paths.

Each level of the data path architecture stands alone such that each level provides line transmission functions asynchronously to the other levels. Each level passes its data packets along the length in concert with its own command and control structure. The data packets are passed along within the same level or are transferred to a higher level at the appropriate station. Data is transferred from one storage buffer to the next giving each level the ability to move data in bursts. Equipment at each step can check the quality of the data packet at each station by temporarily stopping data flow for checking, processing, joining with other data packets, and to provide data re-transmissions when the quality is not acceptable. Equipment at each step can generate and pass on commands to other equipment and sensors downstream from the command level.

Data digitised at the original sensor level may be digitised synchronously with all other digitising stations and transmitted with highly accurate time stamp and sensor position and location information attached to each data packet. This feature of the invention provides real time position and sampling time information necessary for proper sequence alignment of digitised samples, for quality control, and and processing purposes.

System cables include sensor cable section 12 which can be linked into a single cable and sensor strings 18 attached to each cable section. The design provides the ability to move digitised data from individual sensing stations within a group along a single wire pair through a small, low power, digital processing module such as an SDM 16 temporarily attached to one end of sensor string 19. The other end of sensor string 18 is a connector 38 that allows another SDM 16 to connect to adjacent sensor strings 20.

Cable section 10 includes sensor connectors such as takeouts 12 connectable to a low data rate transmission pair in cable section 10 that carries the digital data packet down the cable to IDM 24. SDM 16 connections to the pair of a cable section 10, and for a string of connected cable sections 10 linked together, may be in parallel or in series.

This configuration proposes system architecture to be such that a number of data port connectors such as takeouts 12 will reside at essentially equal intervals along cable section length 10, and that a number of individual port connectors at each connected SDM 16 share a common transmission path within cable section 10. This architecture dedicates the circuit disclosed within cable section 10 the ability to provide digitized data and command and control data packet communication between SDMs 16 deployed along a cable section 10 and the controlling IDM 24. The location of each IDM 24 is selected to stay within specification limits for the number of SDMs 16 and the distance allowed between IDMs 24. This same path carries the data packets from each SDM 16 to a controlling IDM 24 under the command and control of each IDM 24. Line cable section 10 also contains a separate dedicated high speed data path to carry data and command/control between individual IDM 24 units.

Transverse and higher level cables and other data links are designed to carry very high speed data and command/control signals. These links are available in high speed wire designs, fiber optic cable designs, radio link designs, and other communication paths. Multiple communication paths can operate separately or simultaneously to provide dedicated or shared data transmission capabilities.

The system architecture contains multiple levels of data paths, each with successively higher data rates efficiently moving data to the next level for eventual collection by master recording unit 34. Multiples of the lower paths feed into the higher paths and multiples of these paths feed into successively higher paths.

Each level of the data path architecture is stand alone in that it functions asynchronously to the other levels. Each level passes the correlative data packets along its length in concert with its own command and control structure. The data packets are passed along within the same level or are transferred to a higher level at the appropriate station. Data is transferred from one storage buffer to the next giving each level the ability to move data in bursts, to check the quality of a data packet at each station, to temporarily stop data flow for checking, processing, joining with other data packets, and to provide data re-transmissions when quality is unacceptable.

SDMs 16 can also have the ability to communicate with a deploying person with a hand held communicator so as to receive other information regarding the deployed location via an external GPS receiver or can be manually entered with pre-surveyed location identifiers. SDMs 16 can provide equipment deployment personnel with quality control determinations about the electronics, each cable section 10 of the total connected cable, sensors 20, and the deployment quality of sensors 20.

The apparatus and system described herein is particularly suitable to land based and transition zone (mixed land and water) environments difficult to access and to large seismic arrays, however the apparatus and system is also useful for marine and marine bottom cable applications.

Data collected by individual sensors can be stored, processed, and transmitted from different levels within the seismic array, beginning with each SDM 16. The data can then be transmitted at a higher delivery rates from each step to the next until finally received by master recording unit 34. TDMs 30 can be connected in large arrays between IDMs 24 and master recording unit 34 to provide additional control or data processing attributes, and local recorders 36 can provide data processing and transmission attributes before the data is transmitted to master recording unit 34. The system architecture contains multiple levels of data paths each having successively higher data rates. Multiples of lower paths feed into the higher paths and multiples of these paths feed into successively higher data paths. Each level of the data path architecture can stand alone such that each level provides line transmission functions asynchronously to the other levels. The system permits significant flexibility in equipment deployment and further permits asynchronous data transmission from different sensors 20 within a seismic spread.

Although the invention has been described in terms of certain preferred embodiments, it will become apparent to those of ordinary skill in the art that modifications and improvements can be made to the inventive concepts herein without departing from the scope of the invention. The embodiments shown herein are merely illustrative of the inventive concepts and should not be interpreted as limiting the scope of the invention.

What is claimed is:

1. An apparatus for collecting seismic data, comprising:
a cable section having at least two takeouts at selected locations along said cable section;
at least one string data module attachable to one of said takeouts, wherein said string data module includes electronics for transmitting data through said cable section;
a first sensor string having one end attached to said string data module; and
at least one sensor attached to said sensor string for generating seismic data for transmission through said string data module and said cable section.

2. An apparatus as recited in claim 1, further comprising an intermediate data manager connected to one end of said cable section for receiving said data transmitted through said cable section and for retransmitting said data to a selected destination.

3. An apparatus as recited in claim 2, wherein said intermediate data manager is capable of processing the data received from said string data module.

4. An apparatus as recited in claim 2, further comprising a master recording unit in communication with said intermediate data manager for receiving and recording said data.

5. An apparatus as recited in claim 4, wherein said communication link between said intermediate data manager and said master recording unit is capable of transmitting at a faster rate than the transmission of data from said sensor to said intermediate data manager.

6. An apparatus as recited in claim 4 wherein at least two intermediate data managers connected to corresponding cable sections each form a distinct seismic line, and further comprising at least two transverse data managers each connected between a seismic line and said master recording unit for receiving data from said intermediate data managers and for transmitting said data to said master recording unit.

7. An apparatus as recited in claim 4, further comprising a local recorder linked between said intermediate data manager and said master recording unit.

8. An apparatus as recited in claim 6, further comprising a local recorder linked between at least one of said transverse data managers and said master recording unit.

9. An apparatus as recited in claim 1, wherein said takeouts are connected in parallel within said cable section.

10. A system as recited in claim 1, further comprising a second sensor string having one end attached to said first sensor string, and wherein said string data module is capable of processing data received from at least one sensor positioned within the combined length of said first sensor string and said second sensor string.

11. A system for collecting seismic data, comprising:
a plurality of cable sections each having at least two takeouts at selected locations along said cable sections;
a plurality of string data modules each attachable to selected takeouts, wherein each string data module includes electronics for transmitting data through said corresponding cable section;
a sensor string having one end attached to each string data module, wherein each sensor string includes at least one sensor for generating seismic data for transmission through said corresponding string data module and cable section; and
an intermediate data manager linked with said cable sections for receiving said data.

12. A system as recited in claim 11, further comprising a master recording unit in communication with said intermediate data manager for receiving and recording said data.

13. A system as recited in claim 12, wherein at least two intermediate data managers connected to corresponding cable sections each form a distinct seismic line, and further comprising at least two transverse data managers each connected between a seismic line and said master recording unit for receiving data from said intermediate data managers and for transmitting said data toward said master recording unit.

14. A system as recited in claim 13, wherein said communication link between said intermediate data managers and said master recording unit is capable of transmitting at a faster rate than the transmission of data from said corresponding sensor string to said intermediate data manager.

15. A system as recited in claim 13, further comprising a local recorder linked between said intermediate data manager and said master recording unit.

16. A system as recited in claim 11, further comprising at least two intermediate data managers in data communication with a cable section, and wherein said cable section comprises a first dedicated communication path connected directly between said intermediate data managers and comprises a second communication path connected between said takeouts and one of said intermediate data managers.

17. A system as recited in claim 11, wherein said intermediate data manager is capable of transmitting commands to each corresponding string data module.

18. A system as recited in claim 11, further comprising a global positioning receiver engaged with at least one of said string data modules.

19. A system as recited in claim 13, wherein each of said transverse data managers is capable of selectively storing data received from said corresponding string data modules before said data is transmitted toward said master recording unit.

20. A system as recited in claim 13, wherein each of said transverse data managers is capable of selectively processing said seismic data before such data is transmitted toward said master recording unit.
